(19) United States
(12) Patent Application Publication
(10) Pub. No.: US 2021/0252771 A1
(43) Pub. Date: Aug. 19, 2021

(54) AUTOMATIC MACHINE FOR COATING PANELS WITH LEATHER OR FABRICS

(71) Applicant: Gabriella BENASSI, Viareggio (LU) (IT)

(72) Inventor: Venio VASELLI, Viareggio (LU) (IT)

(21) Appl. No.: 17/251,952

(22) PCT Filed: Jun. 15, 2018
(86) PCT No.: PCT/IT2018/000085

§ 371 Date: Dec. 14, 2020

(51) Int. Cl. B29C 63/02; B27N 7/00; B29C 63/04

(52) U.S. Cl. CPC B29C 63/024; B29C 2063/0008; B29C 63/042; B27N 7/005

(57) ABSTRACT

Automatic machine (1) for coating panels with leather or fabrics comprising: —a base (2), provided with a fixed perimeter surround (3), containing a vertically movable supporting surface (4) for a coating material (M) and for a panel (P) to be coated; —two pairs of movable clasps (5, 6), arranged on opposing sides of the perimeter surround (3), parallel to the sides of the surface (4), adapted to determine the preliminary pulling of the coating material (M) in a transversal and longitudinal direction and then its surmounting and folding onto an upper face of the panel (P) to be coated; —means of reversibly lowering the surface (4); —a frame (7), in one piece with the base (2) and above it, carrying a hydraulic piston (8), arranged perpendicular to the surface (4), adapted to block the panel (P) to be coated on the coating material (M) subjected to pulling; —an electronic command and control unit for the moving parts.

### TECHNICAL FIELD OF THE INVENTION

The invention relates to the sector of upholstery machinery.

More specifically, the invention relates to an automatic machine for coating panels, particularly wooden panels of various shapes and dimensions, with leather or fabrics or various types of plies, to be used preferably, but not exclusively, for outfitting the interior of pleasure craft, yachts, etc.

### STATE OF THE ART

Currently, coating of upholstery panels is carried out by hand, using substantially manual procedures.

The individual panel to be coated is set down upon a rigid surface on which the coating material has been placed previously, whether leather or fabric. With one of the sides of the coating material fixed in place, the material is pulled from the opposite side underneath the panel to enable it to adhere to the bottom face thereof. Once the appropriate tension has been achieved, the coating material is fixed to the upper side of the panel, usually by means of stapling. The procedure described is repeated on the remaining three sides of the panel and on the four corners thereof, for which the process remains substantially unchanged with respect to the sides.

This processing technique has the significant drawback of requiring extended working times, a considerable amount of energy from the operator, who can tire quickly, not to mention the high costs and not-always satisfactory quality of the finished panels.

### SUMMARY OF THE INVENTION

It is therefore an object of the invention to overcome the above-mentioned drawbacks related to the current manual procedures for coating upholstery panels.

The object of the invention is achieved by an automatic machine for coating panels with leather or fabrics, according to the main dependent claim 1. Further features of the invention are described in the dependent claims.

The machine object of the invention offers several important advantages, in particular:

it makes it possible to automate the coating of panels of various shapes and dimensions, with leather or fabrics of various types;
It makes it possible to obtain a significant optimization of processing time, a considerable reduction in the physical fatigue of the operator and of processing costs, and an increase in the quality of the finished panels.

### BRIEF DESCRIPTION OF THE DRAWINGS

Further features and advantages of the invention will be more apparent from the detailed description set forth below, with the aid of the figures, which show preferred embodiments thereof, illustrated by way of non-limiting example, wherein:

FIGS. 1-2 show an axonometric and exploded view, respectively, of an automatic machine for coating panels with leather or fabrics, according to the invention;

FIGS. 3-4-5 show a longitudinal cross-section view, an overhead view, and a transversal cross-section view, respectively, of the internal and external structural shape of said automatic machine;

FIG. 6 shows a schematic view of the operating principle of said automatic machine;

FIGS. 7-8-9-10-11 show transversal cross-section and axonometric views of construction details of the automatic machine.

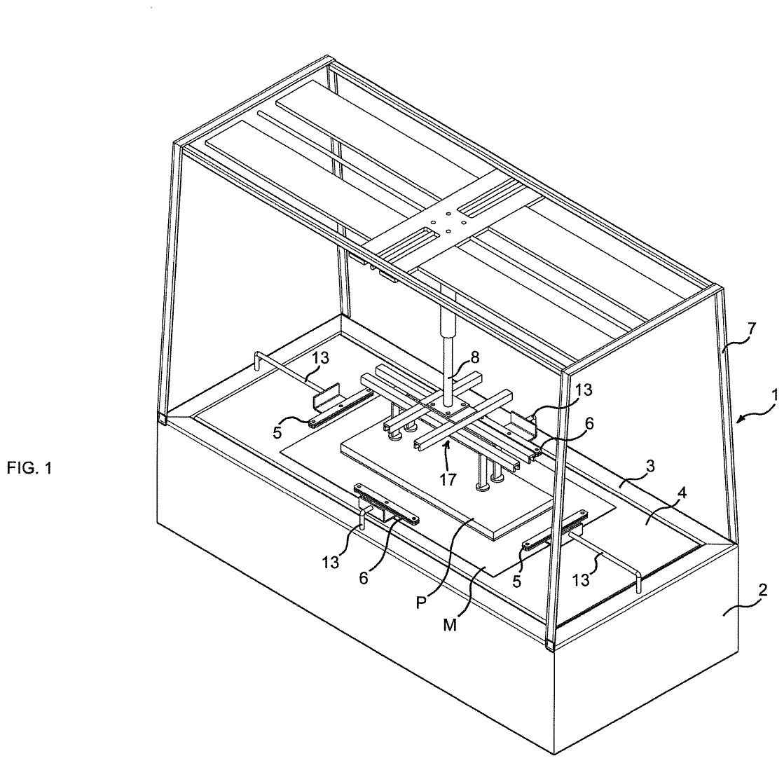

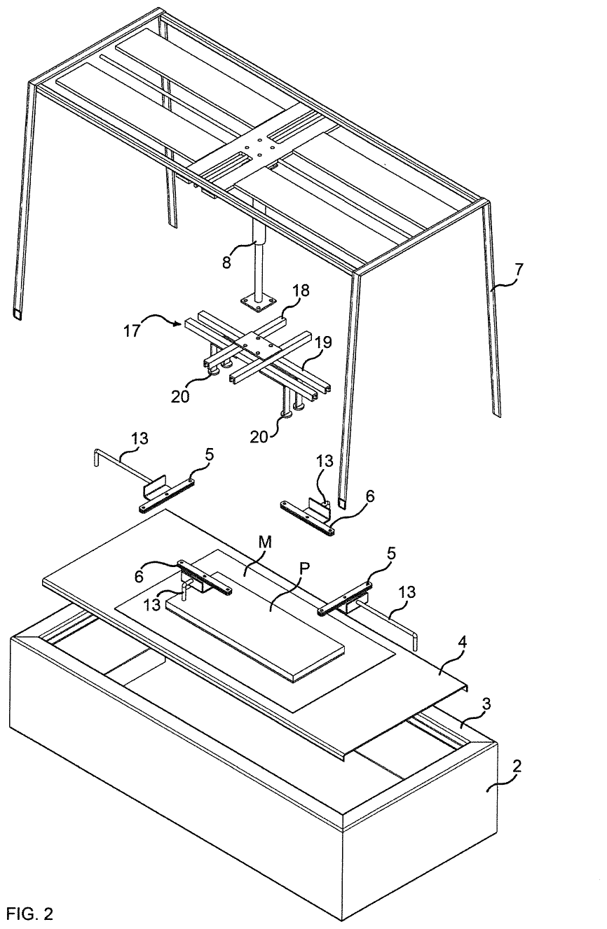

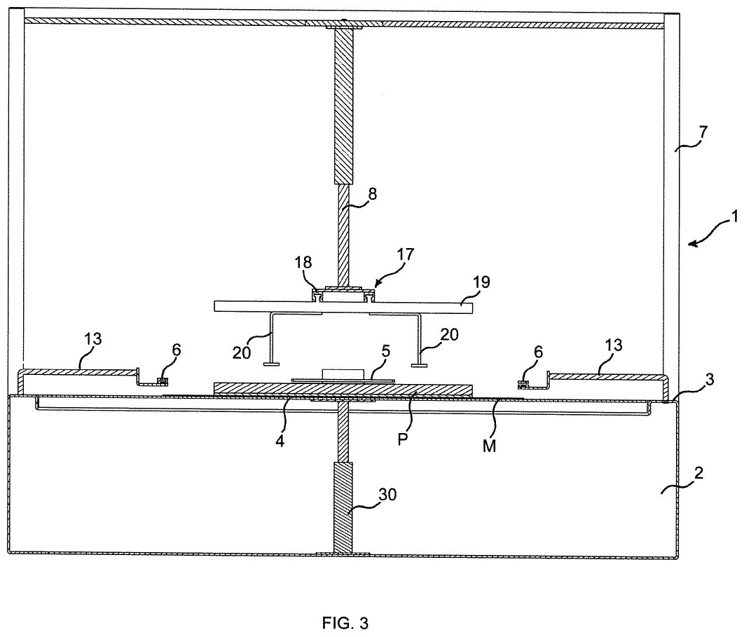

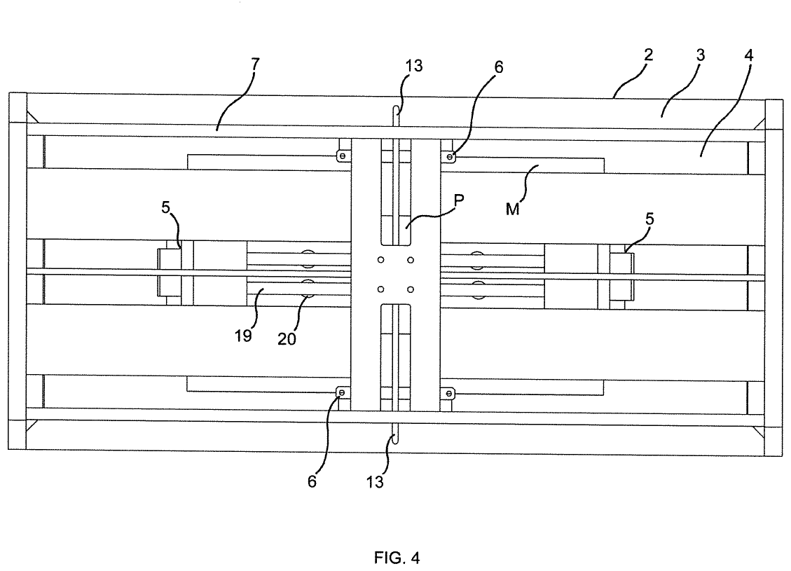

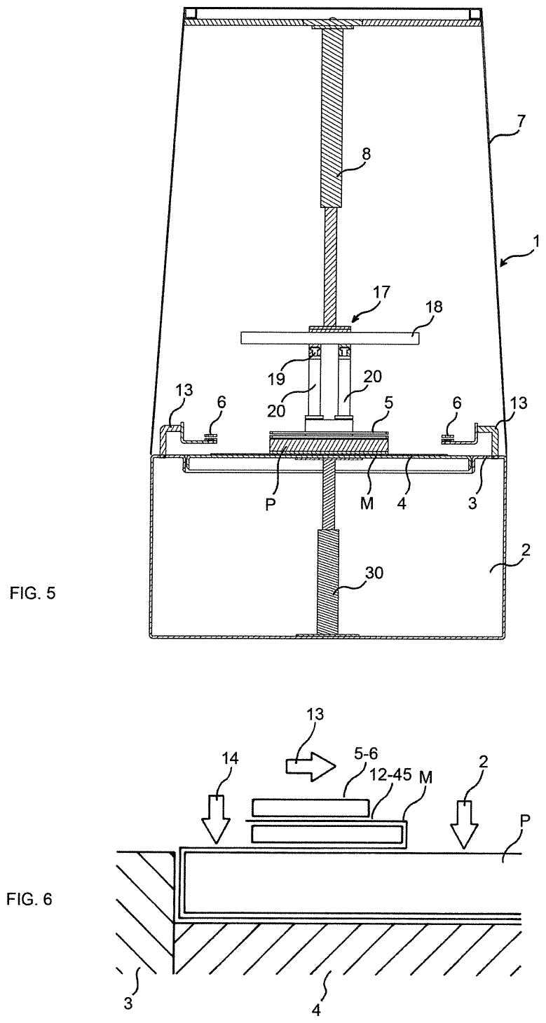

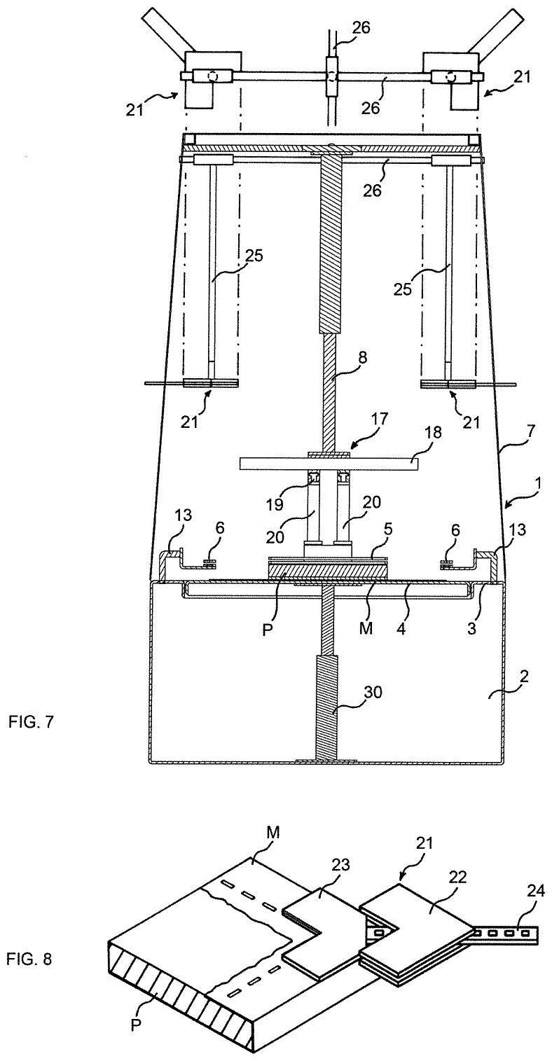

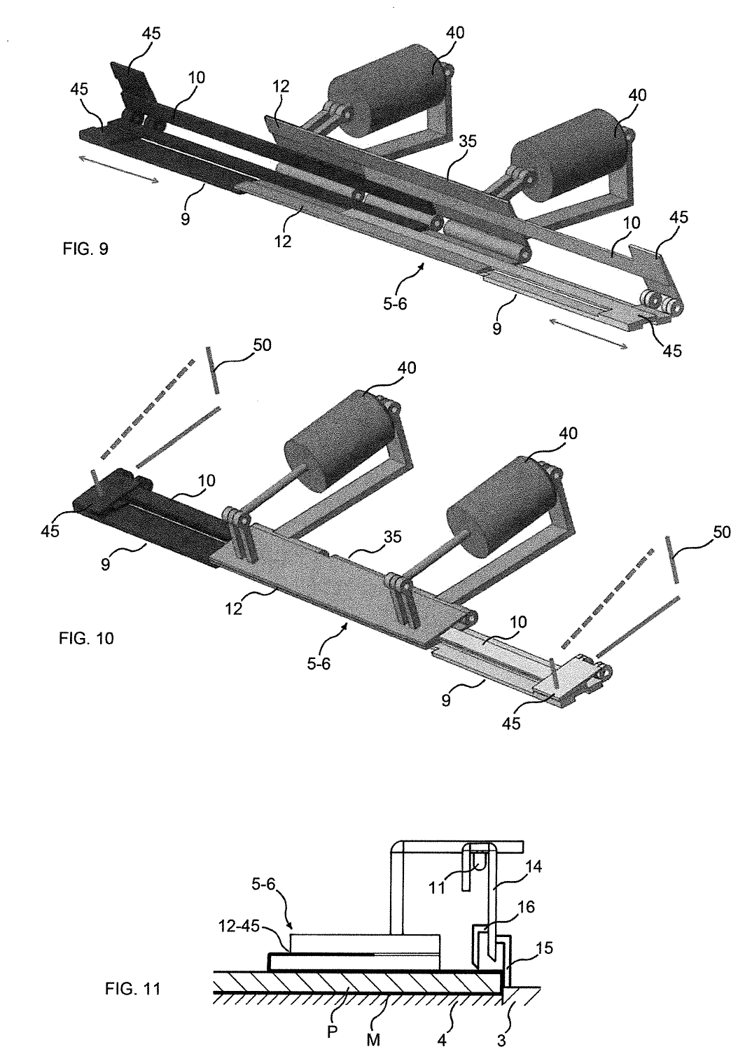

### DETAILED DESCRIPTION OF THE INVENTION

With reference to the details shown in the figures, a machine 1 for coating panels with leather or fabrics, according to the invention, substantially comprises:
   a base 2, provided with a fixed perimeter surround 3, delimiting a vertically movable supporting surface 4 for a coating material M and for a panel P to be coated;
   two pairs of movable clasps 5, 6, arranged on opposing sides of the perimeter surround 3, parallel to the sides of the surface 4, adapted to determine the preliminary pulling of the coating material M in a transversal and longitudinal direction and then its surmounting and folding onto an upper face of the panel P to be coated;
   means of reversibly lowering the surface 4;
   a frame 7, in one piece with the base 2 and resting on top of it, carrying a hydraulic piston 8, arranged perpendicular to the surface 4, adapted to push and cause the blocking of the panel P to be coated on the coating material M subjected to pulling;
   an electronic control unit (not illustrated), associated with the base 2, for the command and control of the moving components;
   electronic devices (not illustrated), associated with the frame 7, adapted to display on a screen or to project onto the surface 4 a centering and/or alignment grid for the panel P to be coated with respect to said pair of movable clasps 5, 6.

The base 2 has a box-like structure, adapted to allow the housing of the various components and operating systems of the machine 1, as well as to enable their easy inspection for maintenance or repair.

In a preferred variant of the invention, the means of reversibly lowering the surface 4 comprise a pneumatic piston 30, located inside the base 2, adapted to allow controlled lowering and raising, or beds of mechanical, elastic or magnetic springs or similar, adapted to allow vertical movement in two directions, in cooperation with the thrust exerted on it by the hydraulic piston 8.

Said surface 4 is made with a shape and dimensions such as to allow the coating of quadrangular panels P, having a flat cross-section, with dimensions of between, for example, 40×70 cm and 80×130 cm, and thicknesses of around 2 cm.

The clasps 5, 6 substantially comprise:

movable sections 9, slidingly associated with a fixed section 35, by means of sliders 10, adapted to allow adjustment of the respective lengths and the consequent management of sheets of coating material M of various dimensions;
grippers 12 for said fixed section 35, either rough or toothed, hinged to one another and driven by first actuators 40, of a pneumatic or hydraulic type, adapted to optimize the grip on the sheets of coating material M of varying consistencies;
grippers 45 for said movable sections 9, either rough or toothed, hinged to one another and driven by possible second actuators 50, of a pneumatic or hydraulic type, adapted to strengthen the grip on the edges of sheets of coating material M with large dimensions;
movable arms 13, associated with said fixed section 35, driven by third actuators, such as electric motors provided with gear motors, adapted to cause the specular movement towards one another or movement away from one another of the clasps 5, 6 from the surface 4 in a direction perpendicular to the sides of the panel P to be coated.

In particular, the clasps 5 arranged on the opposing transversal edges of the perimeter surround 3 of the base 2 have a length that can vary for example between 400 mm and 700 mm, while the clasps 6 arranged on the opposing longitudinal edges of the perimeter surround 3 of the base 2 have a length that can vary for example between 700 mm and 1100 mm.

In possible variants, said movable arms 13 may be of an extendible type, in a single piece with the perimeter surround 3 of the base 2.

In particular, said clasps 5, 6 may be managed in pairs, with specular movements, or singly, with movements independent from one another. The movements of said movable clasps can be controlled from below, through possible through-holes made in the structure of the perimeter surround 3 allowing the inter-connection of the movable arms 13 to the respective actuators, or alternatively from above, by means of possible guides slidingly associated with the frame 7 of the base 2.

In further possible variants, said clasps 5, 6 may also comprise:

automatic staplers 14, sliding on guides 11 associated with the movable sections 9 or fixed sections 35 thereof, adapted to allow hemming of the coating material M along the relevant side of the panel P, provided underneath with a reference element 15, adapted to determine the distance of the hem from the side of the panel P, and with a cutting blade 16, adapted to trim the coating material M at the same time as it is hemmed.

The hydraulic piston 8 for blocking the panel P to be coated on top of the coating material M subject to pulling is associated with a pusher unit 17 comprising:

transversal guides 18, in one piece with the hydraulic piston 8;
longitudinal guides 19, slidingly associated with the guides 18;
thrusting arms 20, slidingly associated with the guides 19.

The combined sliding of the thrusting arms 20 on the longitudinal guides 19 and of the longitudinal guides 19 on the transversal guides 18 allows adjustment of the mutual distance of the thrusting arms 20 and the consequent uniform distribution of the pressure exerted by the hydraulic piston 8 on the panel P to be coated placed on top of the coating material M subject to pulling.

In possible variants, the machine 1 for coating panels P with leather or fabrics, according to the invention, may comprise at least one pair of corner elements 21, adapted to allow the coating of the corners of panels P that have already been coated along the sides.

Said corner elements 21 have package-like structures 22, including corner pressing units 23 sliding diagonally within, controlled by manual or automatic operating levers 24.

Said corner elements 21 are associated with telescopic rods 25, enabling them to be held in a position raised above the surface 4, when at rest, and lowered next to the surface, when in use.

Said telescopic rods 25 are slidingly associated with guides 26 on the frame 7, which allow the reversible association of the corner elements 21 with the corresponding corners of the panel P on the surface 4.

In other possible variants, the machine 1 for coating panels P with leather or fabrics, according to the invention, may comprise at least one electronic control unit and sensor means adapted to detect the shape and dimensions of the panels P placed on the coating material M subject to pulling, so as to manage autonomously the subsequent movements of the movable clasps 5, 6 and of the hydraulic piston 8, and thereby to enable the coating of the afore-mentioned panels P in a fully automatic manner.

Operation of the automatic machine for coating panels with leather or fabrics, according to the invention, can be summed up as described below.

The clasps 5, 6 are adjusted in length by sliding the movable sections 9 on the fixed section 35, by means of the respective sliders 10, so as to adapt them to the dimensions of the sheets of coating material M used.

The coating material M is spread out on the surface 4 of the base 2 and blocked between the grippers 12, 45 of the sections 35, 9 of the clasps 5, 6, controlled by first and second actuators 40, 50 respectively.

The clasps 5, 6 are then activated in pairs, with movements in opposing directions, controlled by the movable arms 13 associated with third actuators, so as to cause a specular moving away from the surface 4 in a direction perpendicular to the sides thereof and a consequent transversal and longitudinal pulling of the coating material M blocked between the grippers 12, 45 of the clasps 5, 6.

The panel P to be coated is placed manually on top of the coating material M subject to pulling and aligned parallel to the clasps 5, 6 with the help of a grid shown on a screen or projected directly on to the material, by means of electronic devices placed on the frame of the base.

The face of the panel P being coated will be the bottom face, placed in contact with the coating material M subject to pulling.

Possibly, the contact faces of the panel P and of the coating material M may be coated with glue beforehand, in the same way that an additional layer of padding material may also be interposed between them.

The thrusting arms 20 of the pusher unit 17 associated with the hydraulic piston 8 are equally spaced, by sliding them on the guides 19, together with a mutual sliding of the guides 19, 18, so as to cause a uniform distribution of the pressure exerted by the hydraulic piston 8 on the panel P.

The hydraulic piston 8 is lowered so that, by means of the pusher unit 17:

the panel P is blocked on the material M subject to pulling and on the surface 4 beneath;
the material M subject to pulling adheres to the lower face of the panel P.

Simultaneously, the surface 4 is lowered by means of the specific pneumatic piston 30, or by means of elastic or magnetic springs, until the substantial alignment of the upper face of the panel P with the perimeter surround 3 of the base 2, so that the panel P can be surmounted by the clasps 5, 6.

The clasps 5, 6 are activated in pairs, with movements in opposing directions, controlled by the movable arms 13 associated with third actuators, so as to cause a specular movement towards the surface 4 in a direction perpendicular to the sides of the panel P and a consequent surmounting and folding of the edges of the coating material M on the upper face of the panel P.

According to a variant of the invention, the vertical movement of the surface 4 can be assisted by a lifting movement of the clasps during the movement to fold the leather or fabric on to the panel.

The material M folded on to the upper face of the panel P in this way can be hemmed along the sides thereof, by means of stapling procedures performed manually or with the help of automatic equipment.

In this regard, the clasps 5, 6 can be fitted with staplers 14, sliding on guides 11, adapted to allow hemming of the coating material M along the relevant side of the panel P, provided underneath with a reference element 15, adapted to determine the distance of the hem from the side of the panel P, and with a cutting blade 16, adapted to trim the coating material M at the same time as it is hemmed.

The panel P, coated along the sides only, is released from the machine 1 by raising the hydraulic piston 8 and the relative pusher unit 17, raising the surface 4 of the base 2, by means of the reversible movement means associated therewith, and the return of the clasps 5, 6 to their initial position on the perimeter surround 3 of the base 2, by means of the movable arms 13 associated with second actuators.

To finish coating the corners, the panel P is placed manually on the surface 4, near the side served by a pair of specific corner elements 21 and with the coated face turned to face downwards.

The corner elements 21 are aligned with the upper face of the panel P, causing them to be lowered onto the telescopic rods 25, and are brought towards the two corners of the panel P, causing the sliding of said telescopic rods 25 on guides 26 of the frame 7 of the base 2.

The hydraulic piston 8 is then lowered so as to block the panel P on the surface 4 and then lower it until the upper face of the panel P is aligned with the perimeter surround 3 of the base 2.

The corner elements 21 include corner pressers 23, whose diagonal sliding in the direction of the panel P, controlled by manual or automatic activation levers 24, causes the coating material M to adhere along the corners of the upper face of the panel, which has been finished and treated with specific glues beforehand.

In order to complete an entire panel, the operations described above are repeated on the remaining pair of corners.

Electronic control units may be used to detect the shape and dimensions of the panels P placed on the coating material M subject to pulling, by means of optical scanning procedures or similar, so as to manage autonomously subsequent movements of the clasps 5, 6, of the hydraulic piston 8 and of the pusher unit 17, and thereby to coat the afore-mentioned panels in a fully automatic manner.

1) Automatic machine for coating panels with leather or fabrics comprising:
a base (2), provided with a fixed perimeter surround (3), containing a vertically movable supporting surface (4) for a coating material (M) and for a panel (P) to be coated;
two pairs of movable clasps (5, 6), arranged on opposing sides of the perimeter surround (3), parallel to the sides of the surface (4), adapted to determine the preliminary pulling of the coating material (M) in a transversal and longitudinal direction and then its surmounting and folding onto an upper face of the panel (P) to be coated;
means of reversibly lowering the surface (4);
a frame (7), in one piece with the base (2) and above it, carrying a hydraulic piston (8), arranged perpendicular to the surface (4), adapted to block the panel (P) to be coated on the coating material (M) subjected to pulling;
an electronic command and control unit for the moving parts.

2) An automatic machine according to claim 1, characterized in that it comprises electronic devices, associated with the frame (7), adapted to display on a screen or to project onto the surface (4) a centering and/or alignment grid for the panel (P) to be coated with respect to said pair of movable clasps (5, 6).

3) An automatic machine according to claim 1, characterized in that said base (2) comprises a box-like structure.

4) An automatic machine according to claim 1, characterized in that said clasps (5, 6) comprise movable sections (9), slidingly associated with a fixed section (35) by means of sliders (10), adapted to allow adjustment of the respective lengths and the consequent management of sheets of coating material (M) of various dimensions.

5) An automatic machine according to claim 4, characterized in that said movable clasps (5, 6) comprise:
grippers (12) for said fixed section (35), either rough or toothed, hinged to one another and driven by first actuators (40), of a pneumatic or hydraulic type, adapted to strengthen the grip on the sheets of coating material (M) of varying consistencies;
grippers (45) for said movable sections (9) either rough or toothed, hinged to one another and driven by possible second actuators (50), of a pneumatic or hydraulic type, adapted to strengthen the grip on the edges of sheets of coating material (M) with large dimensions;
movable arms (13) driven by third actuators, adapted to cause the specular movement towards one another or movement away from one another of the clasps (5, 6) from the surface (4) in a direction perpendicular to the sides of the panel (P) to be coated.

6) An automatic machine according to claim 1, characterized in that said movable clasps (5, 6) comprise:
automatic staplers (14) adapted to allow hemming of the coating material (M) along the relevant side of the panel (P);
a reference element (15) adapted to determine the distance of the hem from the side of the panel (P);
a cutting blade (16) adapted to trim the coating material (M) at the same time as it is hemmed.

7) An automatic machine according to claim 1, characterized in that said means of reversibly lowering the surface (4) comprise a pneumatic piston (30), located inside the base (2), at adapted to allow controlled lowering and raising, or beds of mechanical, elastic or magnetic springs.

8) An automatic machine according to claim 1, characterized in that said hydraulic piston (8) for blocking the panel (P) to be coated on top of the coating material (M) subject to pulling is associated with a pusher unit (17) comprising:
transversal guides (18) in one piece with the hydraulic piston (8);
longitudinal guides (19) slidingly associated with the guides (18);
thrusting arms (20) slidingly associated with the guides (19).

9) An automatic machine according to claim 1, characterized in that it comprises at least one pair of corner elements (21), adapted to allow the coating of the corners of panels (P) that have already been coated along the sides, where said corner elements (21) have package-like structures (22) including corner pressing units (23), sliding diagonally within, controlled by manual or automatic operating levers (24).

10) An automatic machine according to claim 9, characterized in that said corner elements (21) are associated with telescopic rods (25), enabling them to be held in a position raised above the surface (4), when at rest, and lowered next to the surface, when in use.

11) An automatic machine according to claim 10, characterized in that said telescopic rods (25) are slidingly associated with guides (26) on the frame (7), which allow the reversible association of the corner elements (21) with the corresponding corners of the panel (P) on the surface (4).

12) An automatic machine according to claim 1, characterized in that it comprises an electronic control unit and sensor means adapted to detect the shape and dimensions of the panels (P) placed on the coating material (M) subject to pulling, so as to manage autonomously the subsequent movements of the movable clasps (5, 6) and of the hydraulic piston (8) and thereby to enable the coating of the afore-mentioned panels (P) in a fully automatic manner.
